(19) United States
(12) Patent Application Publication
(10) Pub. No.: US 2009/0111072 A1
(43) Pub. Date: Apr. 30, 2009

(54) Dental implant and abutment mating system

(76) Inventors: Alan Lombardo, Kinnelon, NJ (US); Rafail Zubok, Midland Park, NJ (US)

Correspondence Address: WARD & OLIVO, SUITE 300, 382 SPRINGFIELD AVENUE, SUMMIT, NJ, 07901, US

(21) Appl. No.: 12/288,641

(22) Filed: Oct. 22, 2008

Related U.S. Application Data
(60) Provisional application No. 60/983,796, filed on Oct. 30, 2007.

(51) Int. Cl. A61C 8/00

(52) U.S. Cl. 433/174

(57) ABSTRACT

Various embodiments of the present invention relate to devices for dental surgery and more specifically to dental implant and abutment mating system comprising a dental implant secured in the mouth of a patient and an abutment secured to the dental implant, wherein the dental implant and abutment comprise anti-rotational and taper locking elements.

### CROSS-REFERENCE TO RELATED APPLICATION

This application claims priority to U.S. Provisional Application Ser. No. 60/983,796, filed Oct. 26, 2007, the entire contents of which is incorporated herein by reference.

### FIELD OF THE INVENTION

Various embodiments of the present invention relate to devices for dental surgery and the like. More particularly, the present invention relates to a dental implant and abutment mating system, and tools for disengaging same.

### BACKGROUND OF THE INVENTION

While there are many artificial tooth-replacing techniques, single tooth replacements using dental implants and specifically osseointegrated implants are among the more successful dental procedures performed. Some of the apparent advantages include esthetic appearance, comfort, improved hygiene, osseous and gum preservation, versatility, preservation of adjacent teeth, relatively low maintenance and fewer long-term costs. Therefore, the dental industry is continually striving to improve the functionality of the osseointegrated implants with respect to stability and osseointegration.

Typically, there are three states involved in the implantation process of the dental implant. Initially, the dentist surgically embeds the dental implant into the patient's jawbone in the place of the missing tooth. Generally, the dental implant comprises a titanium post, which is screwed into the jawbone and functions as a tooth root substitute. Before the rest of the work is performed, the dentist will install a healing abutment on top of the implant to allow a patient undergo a healing period. The healing period will typically last about three to six months during which the patient's gums heal and osseointegration occurs (a process where the bone fuses to the surface of the implant). After the healing period, the dentist removes the healing abutment and secures a permanent abutment including a replacement tooth on top of the dental implant. However, in some procedures the dentist may secure the permanent abutment including the replacement tooth immediately after implanting the dental implant.

Various systems exist for attaching the permanent abutment to the dental implant and there are a number of factors to consider. The abutment has to be firmly secured to the dental implant to prevent it from dislodging during everyday stresses. However, the securing force cannot be too excessive as it may damage the dental implant during installation thereof. In addition, the abutment has to be sealed with the dental implant to prevent germs from entering the cavity in between the implant and the abutment.

Generally, a dental implant includes a recess on the distal end thereof with a threaded bore extending therein for receiving an abutment. The abutment includes a bore extending therethrough and a projection portion at its lower end that can be inserted in the dental implant's recess. The dental implant's recess and the abutment's projecting portion form a mating region. Once the abutment is placed over the dental implant, a dental screw is inserted through the abutment's bore and screwed into the threaded bore of the dental implant.

The mating region of the dental implant and abutment may comprise anti-rotational devices, which prevent the abutment from rotating with respect to the dental implant. One form of anti-rotation devices include a hex shaped projecting portion that fits into a hex shaped recess of the dental implant. However, the hex shaped recess or projecting region may be easily stripped when an excessive torque force is applied during the installation of the dental screw. Different types of anti-rotation devices were introduced to fix this problem. One type of anti-rotation device includes channels formed in the dental implant's recess and an interfacing protrusion formed outwardly extending from the abutment's projecting portion. This configuration is less likely to become stripped. However, it requires a wider projection portion at the abutment's end to compensate the additional protrusions. Thus, the size of the abutment and dental implant is increased.

The mating region of the dental implant and abutment may also include taper locking devices that prevent the abutment from coming out of the dental implant if the dental screw strips during installation or wears over time. Generally, the dental implant's recess and the abutment's projecting portion comprise tapered walls that interlock by frictional forces when the tapered projection wall of the abutment is inserted in the tapered recess wall of the dental implant. The abutment may be locked to the dental implant via the dental screw. Alternatively, the abutment may comprise a threaded shaft extending below the projecting portion, which can be screwed directly into the dental implant's threaded bore. This configuration, however, prevents the dental implant and abutment to include anti-rotational devices. In addition, most tapered locking devices include large angles on the tapered walls, which require a large downward force to achieve optimum lock. Such a force may cause the dental implant or the abutment to crack.

As such, there is a clear need for a dental implant and abutment mating system that can be easily assembled with minimal force while firmly securing the dental implant and abutment. In addition, there is a clear need for a dental implant and abutment mating system that efficiently incorporates anti-rotational and taper locking devices.

### SUMMARY OF THE INVENTION

Thus, it is an object of the present invention to provide a dental implant and abutment mating system that is easily assembled.

It is also an object of the present invention to provide a dental implant and abutment mating system that can be assembled with a minimal force.

It is also an object of the present invention to provide a dental implant and abutment mating system that can be sealed from bacteria and other environmental damages.

It is also an object of the present invention to provide a dental implant and abutment mating system that includes anti-rotational and taper locking portions.

It is also an object of the present invention to provide a dental implant and abutment mating system that prevents the abutment from being dislodged from the dental implant because of vertical or rotational forces.

It is also an object of the present invention to provide a dental implant and abutment mating system that promotes osseointegration.

It is also an object of the present invention to provide an abutment removal tool for easily removing an abutment from the dental implant.

It is also an object of the present invention to provide a universal abutment removal tool that removes different types of abutments, such as straight and angled abutments, from a dental implant.

Other objects, features and characteristics of the present invention, as well as the methods of operation and functions of the related elements of the structure and the combination of parts and economies of manufacture will become more apparent upon consideration of the following detailed description with reference to the accompanying drawings, all of which form a part of this specification.

According to one embodiment of the present invention, a dental assembly is provided comprising a dental implant having a first body and a proximal mating. The proximal mating area includes a first tapered wall, a first internal aperture, and a plurality of first anti-rotational elements. The dental assembly further comprises an abutment having a second body, a second internal aperture and a distal mating area. The distal madding area includes a second tapered wall and a plurality of second anti-rotational elements. The anti-rotational elements allow for timing the geometry of the abutment to the required position of the oral cavity. The proximal mating area is coupled to the distal mating area, thereby coupling the plurality of first anti-rotational elements to the plurality of second anti-rotational elements. The dental assembly further comprises a screw having a head portion and a threaded screw portion, wherein the threaded screw portion is coupled to the first internal aperture of the dental implant.

According to another embodiment of the present invention, a dental device is provided comprising a body having an external surface including a tapered wall. Wherein the tapered wall is provided at a proximal end of the body, and wherein the tapered wall having a first upper wall and a second bottom wall. The dental device further comprises a mating area included within the body and below the first upper wall having a first internal aperture. Wherein the internal aperture comprises a second tapered wall and a plurality of anti-rotational elements. The plurality of anti-rotational elements allow for timing the geometry of the abutment to the required position of the oral cavity. A bore is provided within the body, below the proximal mating area, wherein the bore includes a plurality of internal threads.

According to another embodiment of the present invention an abutment comprising a body having an external surface, wherein the body includes a proximal end and a distal end. A bore is provided within the body, wherein the bore is longitudinal to the body and transverses the entire length of the body. A mating area coupled to the proximal end of the body, wherein the mating area comprises a plurality of anti-rotational elements. Wherein the plurality of anti-rotational elements allow for timing the geometry of the abutment to the required position of the oral cavity. A tapered wall coupled to the mating area, wherein the tapered wall has an upper wall and a bottom wall, wherein the tapered wall further comprises an inner wall having an angle from the upper wall to the bottom wall.

According to another embodiment of the present invention, a method of using a dental assembly is provided. The method comprising the steps of: drilling a receiving aperture in a patients jawbone; attaching a distal portion of a dental implant into the receiving aperture; wherein the dental implant also has a first body portion and a first aperture therein, wherein the first aperture comprises a proximal mating area having a first tapered wall and a first anti-rotational elements and a bore positioned underneath, wherein the bore comprises a plurality of internal threads; attaching a second mating area of an abutment to the proximal mating area, wherein the second mating area having a second tapered wall and a second anti-rotational elements, thereby locking the abutment to the dental implant, wherein the abutment also having a second body and a second internal aperture traversing therethrough; inserting a screw into the second internal aperture; and rotating the screw thereby threadably coupling the dental screw to the dental implant.

### BRIEF DESCRIPTION OF THE DRAWINGS

A further understanding of the present invention can be obtained by reference to a preferred embodiment, along with some alternative embodiments, set forth in the illustrations of the accompanying drawings. Although the illustrated embodiments are merely exemplary of systems for carrying out the present invention, the organization and method of operation of the invention in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following Figures:

FIG. 1A is a partial cross-sectional view of a dental implant according to an embodiment of the present invention.

FIG. 1B is a top view of the dental implant shown in FIG. 1A according to an embodiment of the present invention.

FIG. 2A is a partial cross-sectional side view of an abutment according to an embodiment of the present invention.

FIG. 2B is a bottom view of the straight abutment shown in FIG. 2A.

FIG. 3 shows a side view of a dental screw according to an embodiment of the present invention for use with the dental implant of FIGS. 1A-1B and the straight abutment of FIG. 2A-2B.

FIG. 4A is a partial cross-sectional side view of the dental implant according to an embodiment of the present invention.

FIG. 4B is a top view of the dental implant shown in FIG. 4A.

FIG. 5A is a partial cross-sectional view of an angled abutment in accordance to an embodiment of the present invention.

FIG. 5B is a bottom view of the angled abutment shown in FIG. 5B.

FIG. 6 shows a side view of a dental screw according to an embodiment of the present invention for use with the dental implant of FIGS. 4A-4B and the angled abutment of FIGS. 5A-5B.

FIG. 7 shows an assembled side view in partial cross-section of dental screw of FIGS. 4A-4B, angled abutment of FIGS. 5A-5B and dental screw of FIG. 6 according to an embodiment of the present invention.

FIG. 8A is a partial cross-sectional side view of an exemplary temporary abutment according to an embodiment of the present invention.

FIG. 8B is a side view in partial cross-section of a cover screw according to an embodiment of the present invention.

FIG. 9 is a cross-sectional view of a straight abutment for receiving an abutment-removing tool according to an embodiment of the present invention.

FIG. 10 is a cross-sectional view of an abutment removal tool according to an embodiment of the present invention.

FIG. 11 illustrates a method of removing an abutment from a dental implant using the abutment removal tool of FIG. 10.

FIG. 12 is a cross-sectional view of an abutment removal tool according to another embodiment of the present invention.

FIG. 13 illustrates a method of removing an abutment from a dental implant using the abutment removal tool of FIG. 12.

### DETAILED DESCRIPTION OF THE INVENTION

A detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific functional details disclosed herein are merely representative, yet in that regard, they are deemed to afford the best embodiment for purposes of disclosure and to provide a basis for the claims herein which define the scope of the present invention.

Moreover, well known methods and procedures for both carrying out the objectives of the present invention and illustrating the preferred embodiment are incorporated herein but have not been described in detail as not to unnecessarily obscure novel aspects of the present invention.

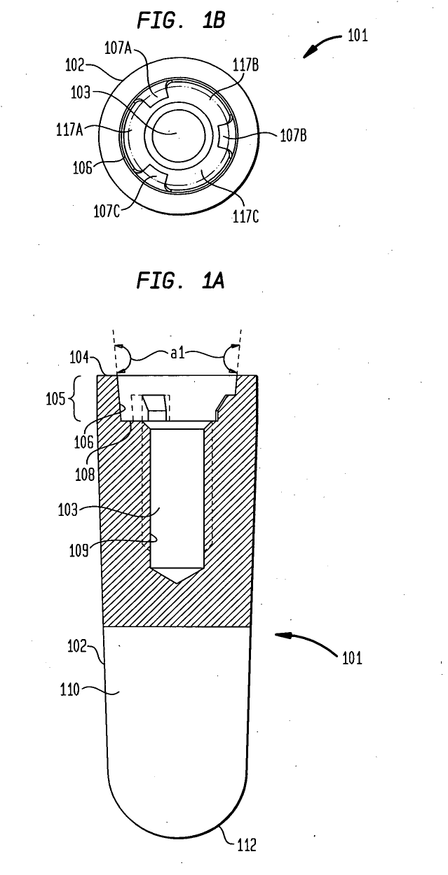

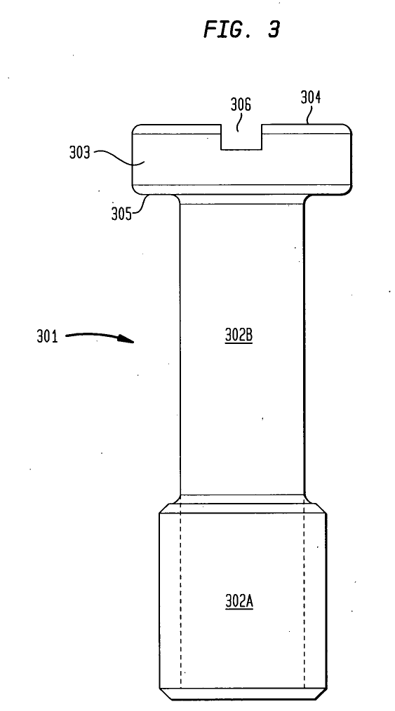

Referring now to FIGS. 1A-1B, various views of dental implant 101 according to an embodiment of the present invention are shown. FIG. 1A is a partial cross-sectional view of dental implant 101 and FIG. 1B is a top view of dental implant 101. As seen in FIGS. 1A-1B, dental implant 101 generally includes a generally cylindrical body 110 having an external surface 102, mating area 105 and bore 103. Body 110 is generally cylindrical in shape from a generally flat first end, comprising upper wall 104, to a semi-spherical end 112. Body 110 is preferably tapered from a first end 104 to semi-spherical end 112. Body 110 is provided to be fitted in a patient's jawbone with end 112 being received in an aperture (not shown) in a patient's jawbone. Upper wall 104 extends inwardly from external surface 102 and mating area 105 extends below upper wall 104 of dental implant 101. Mating area 105 comprises inner wall 106 that tapers down between upper wall 104 and bottom wall 108 of mating area 105. Mating area 105 further comprises arcuate shaped elements 107A-107C, which cooperatively enclose cavities 117A-117C therein. Although three cavities 117A-117C are illustrated, having a particular shape, any desired number and shape of elements may be provided without departing from the scope of the present invention. Bore 103 is located below mating area 105 inside body 110 and comprises an inner wall 109, which may be internally threaded (not shown) for receiving therein screw 301 shown in FIG. 3.

External surface 102 of dental implant 101 may include external threads (not shown)on body 110 for use in securing dental implant 101 in the jawbone of a patient by selectively inserting body 110 into cavity (not shown) formed in the jawbone of a patient. Generally, the jawbone is predrilled and dental implant 101 is secured by being screwed into the jawbone using a driver. The driver may be configured to have, at a distal end thereof, features that interface with elements 107A-107C of mating area 105. The jawbone may be threaded for receiving dental implant 101, or alternatively, dental implant 101 may have self-tapping screw threads used to drive dental implant 101 into the jawbone without pre-threading the jawbone. In another non-limiting example, dental implant 101 may be secured in the mouth of a patient using cement, either alone or in conjunction with the screw fixation discussed above. The dental implant 101 may be secured in the mouth of a patient so that the upper wall 104 is essentially flush with the top exposed surface of the jawbone, above the jawbone or below the jawbone as required.

At least part of external surface 102 of dental implant 101 may be acid-etched to produce a rougher surface promoting osseointegration. In another example, at least part of external surface 102 of dental implant 101 may be coated with a substance that increases surface area, such as calcium phosphate ceramics, including tricalcium phosphate (TCP), hydroxyapatite (HA), or the like.

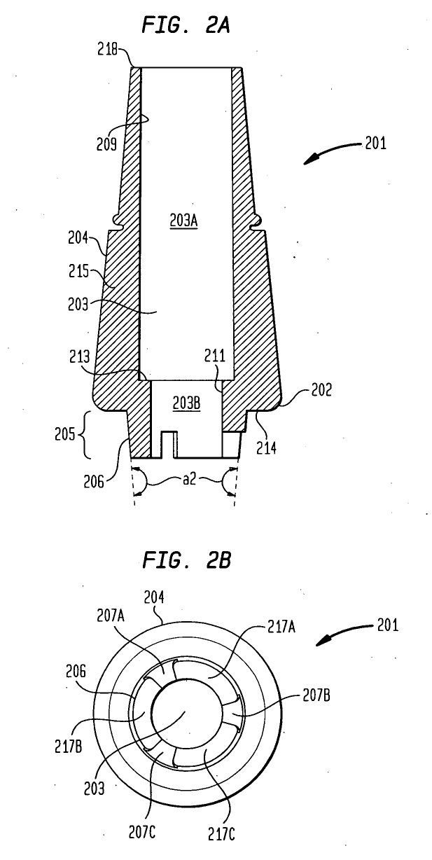

Referring now to FIGS. 2A and 2B, various views of straight abutment 201 according to an embodiment of the present invention are shown. FIG. 2A is a partial cross-sectional side view of abutment 201 and FIG. 2B is a bottom view of straight abutment 201. As shown in FIG. 2A, abutment 201 is used to support prosthetic teeth or any other device. Although straight abutment 201 is illustrated, any type of abutment known in the art can be used without departing from the scope of the invention, including, but not limited to healing caps, impression copings, temporary abutments, permanent abutments, prosthetic teeth, angled abutments, integrated crown abutment, or the like. As seen in these figures, straight abutment 201 generally comprises a generally cylindrical body 215 having an outer surface 204, mating area 205 and bore 203. Bore 203 is longitudinally coextensive with length of body 215 and comprises a first aperture, having a wider diameter 203A with inner vertical wall 209, connected via circumferential edge 213 to a second aperture, having a narrower diameter 203B with inner vertical wall 211. Outer surface 204 tapers down towards the distal end 218 of abutment 201. Of course, the configuration of outer surface 204 will vary depending on the type of abutment used. Bottom wall 214 inwardly extends from outer surface 204 forming curved surface 202. Mating area 205 is coupled to body 215 below bottom wall 214 and comprises a tapered wall 206 and elements 207A-207C, forming three curved protrusions 217A-217C. Of course, any desired number and shape of elements 207A-207C may be provided. Elements 207A-207C of straight abutment 201 are configured to be complementary to and mate with elements 107A-107C of dental implant 101. In this regard, straight abutment 201 may have protrusions and dental implant 101 may have corresponding cavities, straight abutment 201 may have cavities and dental implant 101 may have corresponding protrusions, or any combination thereof.

Referring now to FIG. 3, there is shown a side view of dental screw 301 according to an embodiment of the present invention for use with the dental implant 101 of FIGS. 1A-1B and straight abutment 201 of FIGS. 2A-2B is shown. Dental screw 301 comprises a generally cylindrical head portion 303, including first end 304 and lower end 305. Head portion 303 has a plurality of substantially similar grooves, such as grooves 306, which are provided at first end 304 to receive a flat edge (not shown) of an implement or tool in order to rotate dental screw 301. Further, lower end 305 is fixably and orthogonally coupled to a generally cylindrical and solid portion 302B that terminates into a threaded portion 302A. Threaded portion 302A has a plurality of circumferential threads (not shown)on external surface of portion 302A provided to threadably and selectively couple threaded portion 302A to threaded surface 109 in bore 103. In this regard, dental screw 301 may be used to selectively couple straight abutment 201 to dental implant 101, wherein mating area 105 of dental implant 101 and mating area 205 of straight abutment 201 are adjacent to one another. To accomplish this, dental screw 301 may be inserted through wider portion 203A and narrower portion 203B of bore 203 in straight abutment 201 and screwed into bore 103 of dental implant 101. Thereby, lower surface 305 of dental screw 301 is forced against lip 213 at the junction of wider portion 203A and narrower portion 203B of straight abutment 201.

In various examples, dental screw 301 may be driven by a slotted screwdriver, a Phillips screwdriver, an Allen wrench, a hex driver or any other desired driver interfacing with a complementary feature associated with head 303 of dental screw 301. In addition, head 303 may include a substantially similar mating area (not shown) to mating area 105 to be used with a driver configured to have, at a distal end thereof, features that interface with such mating area. As such, a single driver may be utilized to screw dental implant 101 into the patient's jawbone and also to screw dental screw 301 to attach abutment 201 on dental implant 101.

At the beginning of the surgery, the dentist would predrill the patient's jawbone to a size viable for receiving dental implant 101. Dental implant 101 may then be screwed into the jawbone using a driver. Abutment 201 is then secured onto dental implant 101 through capillary force. The elimination of rotational forces in securing dental implant 101 and abutment 201 reduces the stress between the components, which can lead to damage thereof. As mating area 205 of abutment 201 is inserted in mating area 105 of dental implant 101, tapered wall 206 of mating area 205 engages tapered wall 106 of mating area 105 forming a locking taper. According to the present invention, tapered walls 106 and 206 are preferably tapered at slopes a1 and a2 to achieve an optimum sealable fit so dental implant 101 and abutment 201 can be held together without dental screw 301. This assists the dentist during the implant installation so when dental implant 101 and abutment 201 are engaged they are less likely to be disengaged while the dentist is preparing to install dental screw 301. Preferably, tapered walls 106 and 206 are tapered at the same angle to achieve a sealable fit. Tapered slopes a1 and a2 preferably comprise a range of 1-10 degrees and more preferably a range of 1-5 degrees to achieve the optimum locking taper.

In addition, as abutment 201 engages dental implant 101, elements 207A-207C of mating area 205 mate with elements 107A-107C of mating area 105. As such, protrusions 217A-217C are inserted into cavities 117A-117C. Elements 107A-107C and elements 207A-207C inhibit relative rotation between dental implant 101 and straight abutment 201 and as such function as anti-rotational elements. In addition, elements 107A-107C and elements 207A-207C assist the dentist in timing the geometry of dental implant 101 with respect to the jaw of the patient such that abutment 201 is installed in the required position of the oral cavity. Elements 107A-107C and elements 207A-107C may be configured in various designs to minimize stress, reduce high stress concentrations, minimize the probability of chipping, cracking, wear and the like. This can be achieved by utilizing one or more chambers, one or more curves, one or more radii or the like.

Dental screw 301 is then screwed to further insert mating area 205 of abutment 201 into mating area 105 of dental implant 101. As such, tapered walls 106 and 206 are further locked through frictional fit. The combination of the tapering lock and anti-rotational mechanisms, as well as the angles and designs of protrusion and chambers involved, ensure that abutment 201 is well secured to dental implant 101, preventing abutment 201 from being dislodged as of vertical or rotational forces. Such mating area configuration will retain the frictional and anti-rotational forces even if dental screw 301 wears out or the threads on threaded shaft 302A or bore 103 are stripped during installation of abutment 201 with dental implant 101. Additionally, the locking tamper seals the inside of the components from bacteria and other environmental damages.

The dental implant, the abutment or dental screw may be made from any desired materials, including, but not limited to, plastics, fibers, polymers, metals, biocompatible materials or the like. Examples of metals may include, but not limited to, a pure metal such as titanium and/or an alloy such as Ti—Al—Nb, Ti-6Al-4V, and stainless steel. In addition, any biocompatible material may be utilized which may be treated to permit surface bone ingrowth or prohibit surface bone ingrowth, depending upon the desire of the surgeon.

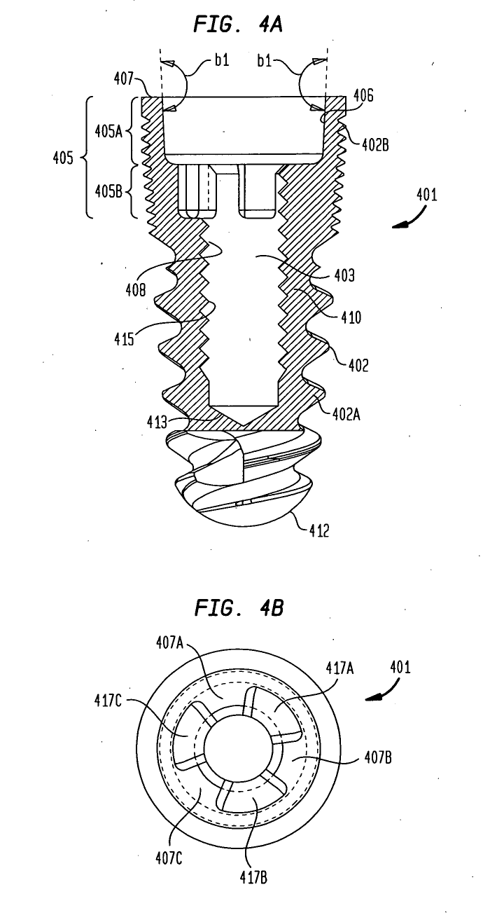

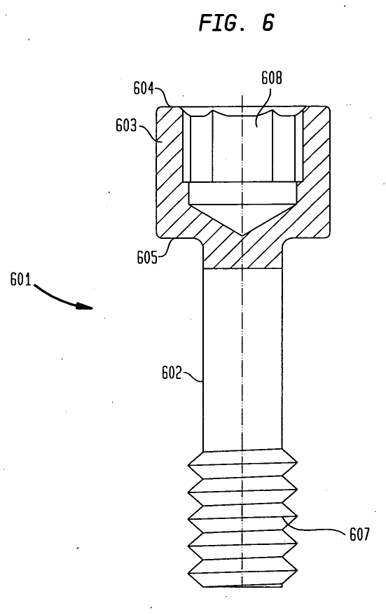

Another aspect of the present invention is illustrated in FIGS. 4A-4B. FIG. 4A is a partial cross-sectional side view of dental implant 401 and FIG. 4B is a top view of dental implant 401. Referring to FIGS. 4A-4B, dental implant 401 is illustrated comprising a generally cylindrical body 410 having an external surface 402, bore 403 and mating area 405. Particularly, body 410 is generally elongated in shape and preferably tapered from upper wall 407 to a semi-spherical end 412. External surface 402 may comprise threads 402A for screwing dental implant 401 into a jawbone of a patient. External surface 402 includes a plurality of substantially similar grooves, such as grooves 402B that engage with the patient's jawbone for preventing dental implant 401 from being unscrewed. Bore 403 comprises an aperture having a longitudinal length from upper wall 407 to aperture end 413. Bore 403 further comprises inner wall 408, which includes threads 415 for being engaged with complementary threads 607 of dental screw 601 shown in FIG. 6.

In this embodiment, mating area 405 includes a separate taper lock region 405A and an anti-rotational region 405B. This configuration maximizes taper lock and anti-rotational forces. Taper lock region 405A comprises an inner wall 406 tapered at slope b1. Slope b1 preferably is in the range of 1-10 degrees, although in other non-limiting embodiments, slope b1 may be in the range of 1-5 degrees. Anti-lock region 405B includes a plurality of anti-lock elements 407A-407C having cavities 417A-417C. Preferably, anti-lock elements 407A-407C are utilized to allow three timing positions, however, any number of anti-lock elements may be introduced without departing from the scope of the present invention.

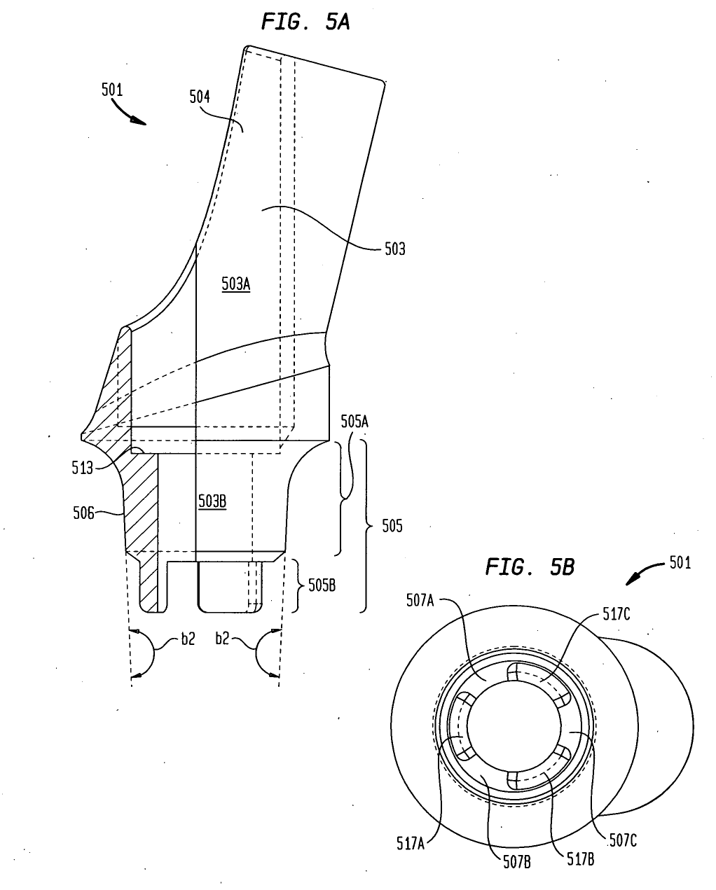

Abutment 501 is used with dental implant 401 as is illustrated in FIGS. 5A-5B. FIG. 5A is a partial cross-sectional view of an angled abutment 501 and FIG. 5B is a bottom view of angled abutment 501. Abutment 501 generally includes an angled upper region 504, which can be configured into other types of abutments previously described and known in the art. Upper region 504 is generally hollow and includes a bore 503, with wider portion 503A and narrower portion 503B connected at lip 513. Lower region of abutment 501 has a generally tubular mating area 505 including taper lock region 505A and anti-rotational region 505B. Anti-rotational region 505B includes elements 507A-507B forming three protrusions 517A-517C. Taper lock region 505A includes a circumferential wall 506 generally tapered at slope b2, preferably in the range of 1-5 degrees for achieving optimum locking taper, although in another non-limiting embodiment, slope b2 is in the range of 1-10 degrees.

FIG. 6 illustrates a side view of dental screw 601 for use with the dental implant of FIGS. 4A-4B and the angled abutment of FIGS. 5A-5B. Dental screw 601 includes head 603, which has first end 604 and second end 605 and encloses a cavity 608. Head 603 terminates into a generally cylindrical shaft 602, which is orthogonally and fixably coupled at end 605. Shaft 602 is generally cylindrical and solid and comprise threads 607. Threads 607 are provided to be coupled to threads 415 on wall 408 of abutment 401. Cavity 608 has an aperture that is shaped for receiving a hex driver (i.e., bore 608 is a female part which receives the male hex driver). Of course, head 603 may be configured to receive other types of drivers.

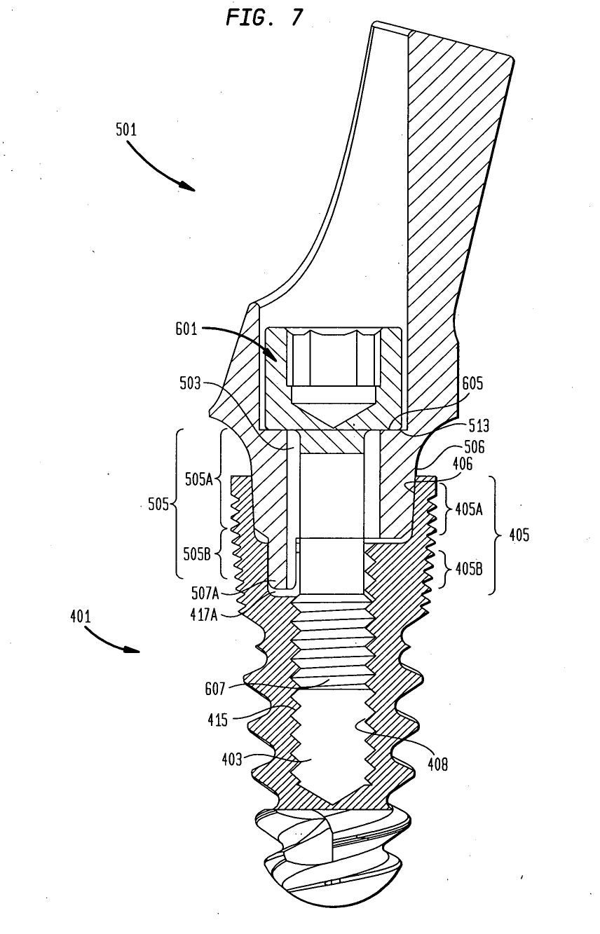

FIG. 7 illustrates an assembled side view in partial cross-section of dental implant 401, abutment 501 and dental screw 601. As shown, mating area 505 of abutment 501 is inserted in mating area 405 of dental implant 401. Each protrusion 507A-507C of abutment 501 will engage corresponding cavity 417A-414C of dental implant 401. When three anti-locking elements are utilized, a user may attach abutment 501 in three positions. However, other number of anti-locking elements may be provided as needed without departing from the present invention. The anti-rotation regions 405B and 505B will prevent abutment 501 from rotating in any direction with respect to dental implant 401. Furthermore, tapered wall 506 of abutment 501 engages tapered wall 406 of dental implant 401, forming a tapered lock. The tapered lock prevents abutment 501 from disengaging from dental implant 401. Dental screw 601 is then inserted through bores 503 and 403 of abutment 501 and dental implant 401, respectfully. A driver (not shown) is used to screw dental screw 601 downwardly, causing threads 607 to engage threads 415 located on inner wall 408 of bore 403. When fully screwed in, dental screw's end 605 will abut lip 513 of abutment 501. As dental screw 601 is screwed in, taper-lock region 505A of abutment 501 is continually forced against taper-lock region 405A of dental screw 401, further locking abutment 501 in dental implant 401. As such, even if screw 601 becomes stripped or loosened in the future, the taper-lock mechanism will continue to secure abutment 501 on dental implant 401.

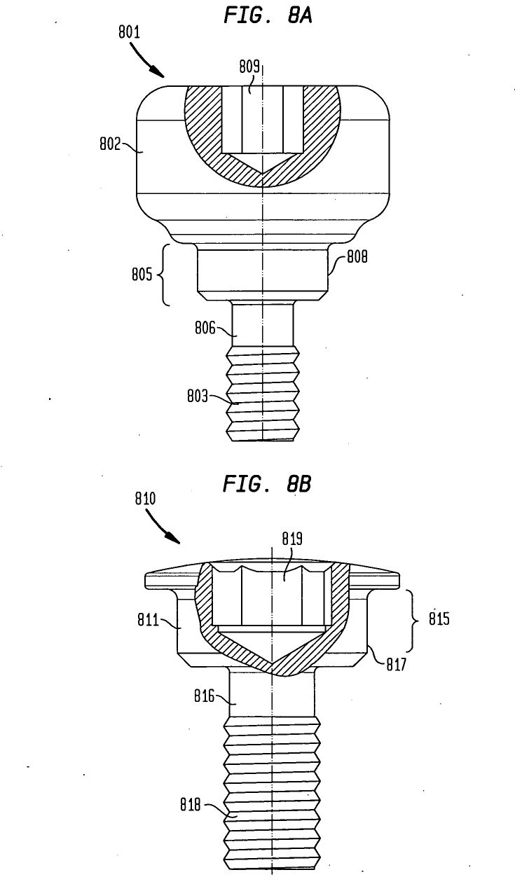

FIGS. 8A and 8B shown examples of abutments 801 and 810, which can be temporarily screwed into dental implant 401, in accordance with the present invention. Specifically, FIG. 8A illustrates a partial cross-sectional side view of healing abutment 801 having a cap 802, mating area 805 and shaft 806. Cap 802 comprises a bore 809, which is formed to receive a hex driver (not shown) for screwing healing abutment 801 into dental implant 401. Shaft 806 includes a plurality of circumferential threads 803 to engage threads 415 on wall 408 of dental implant 401 during installation. Furthermore, mating area 805 has a side wall 808, which is inserted to seal mating area 405A of dental implant 401. Side wall 808 is preferably not tapered so that it can be easily removed when the gums of a patient are healed.

Similarly, a side view in partial cross-section of cover screw 810 is illustrated in FIG. 8B. Cover screw 810 includes a cover head 811, mating area 815 and shaft 816. Shaft 816 is preferably threaded with threads 818 to engage the threads 415 located on wall 408 of dental implant 401. Mating area 815 comprises a wall 817, which engages wall 406 of dental implant 401. Wall 817 is preferably not tapered so that cover screw 810 is not locked to dental implant 401 and can be easily removed. Cover head 811 and mating area 815 have a bore 819 therein for receiving a hex driver (not shown). As cover screw 810 is screwed into dental implant 401, head 811 engages upper wall 407 of dental implant 401 to for a temporary seal.

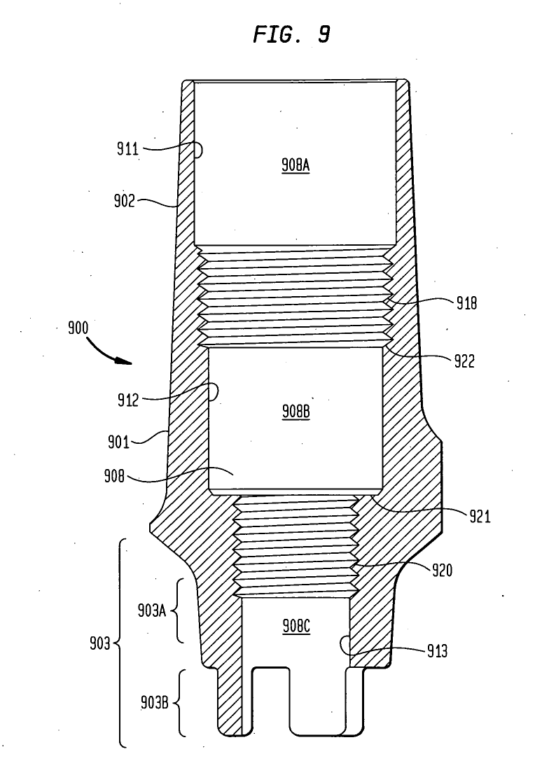

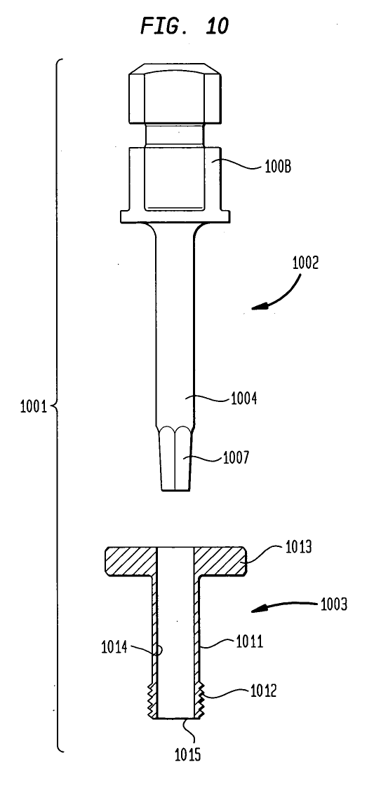

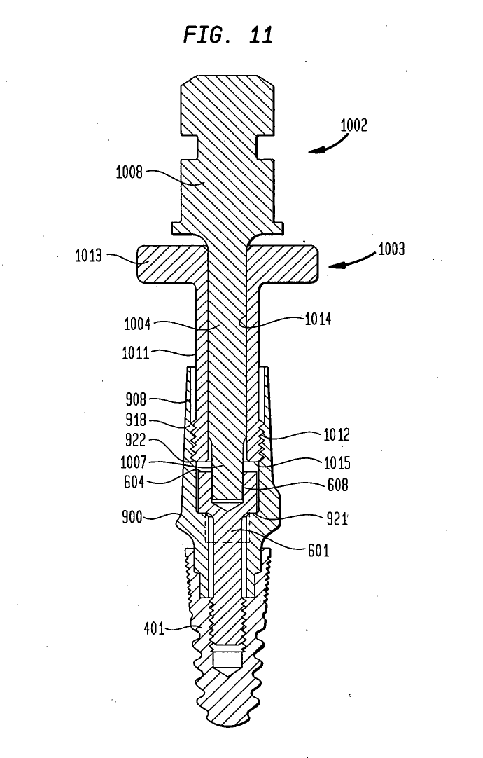

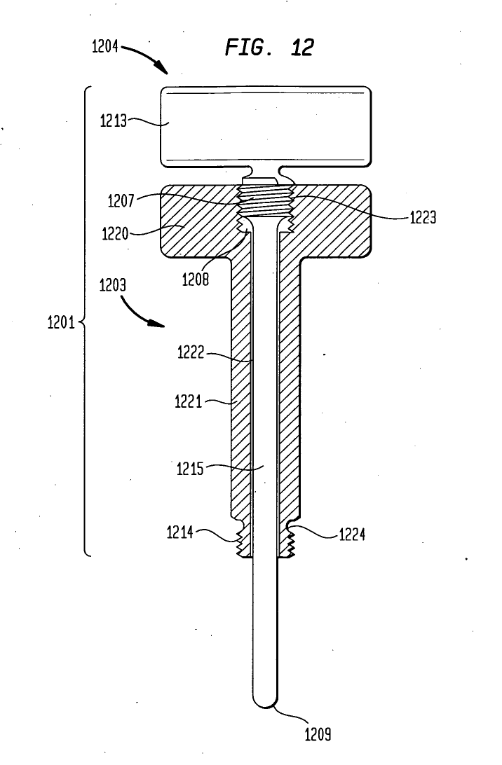

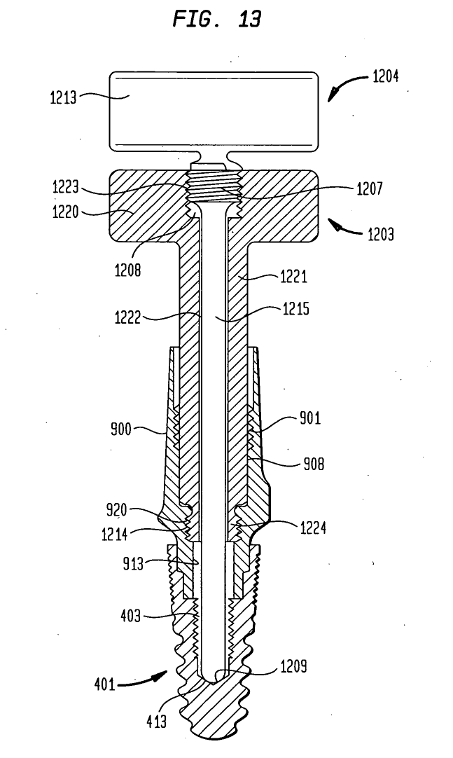

FIG. 9 illustrates a cross-sectional view of an embodiment of a straight abutment for fitting into dental implant 401. Straight abutment 900 comprises a generally cylindrical body 901 having an outer surface 902 and mating area 903. Mating area 903 fits with mating area 405 of dental implant 401 and comprises taper lock region 903A and anti-rotation region 903B. Straight abutment 900 further includes bore 908 that is longitudinally coextensive with length of body 901. Bore 908 comprises a first diameter 908A connected to a second diameter 908B at tip 922, and second diameter 908B connected to a third diameter 908C at lip 921. First diameter 908A comprises inner vertical wall 911 and is wider than second diameter 908B. Second diameter 908B comprises inner vertical wall 912 and is wider than third diameter 908C. Third diameter 908C comprises inner vertical wall 913. Inner vertical wall 912 comprises threading 918 on the upper region thereof that end at tip 922. Threading 918 comprises a left hand threading for engaging an abutment removal tool 1001 later described in reference to FIGS. 10 and 11. Inner vertical wall 913 also comprises threading 920 for engaging a universal abutment removal tool 1201 later described in reference to FIGS. 12 and 13. It is understood that straight abutment 900 does not require both threading 918 and 920, but may comprise either threading 918 or 920 for use with either of the later described tools.

Turning now to FIG. 10 an abutment removal tool 1001 is illustrated. Abutment removal tool 1001 is used to assist the dentist in disengaging an abutment, such as straight abutment 900, from a dental implant, such as dental implant 401. Abutment removal tool 1001 comprises hex driver body 1002 and insert body 1003. Hex driver body 1002 includes a shaft portion 1004 that comprises hex tip 1007 of same size as cavity 608 of dental screw 601. Hex driver further includes head portion 1008 that can be engaged by a manual screwing tool or a drill (not shown). Insert body 1003 comprises shaft 1011, head portion 1013, and bottom end 1015. Shaft 1011 includes threaded portion 1012 that comprises left hand threading. Insert body 1003 also comprises bore 1014 that is longitudinally coextensive with length of insert body 1003. Bore 1014 comprises a diameter adopted to receive the diameter of shaft 1004 of hex driver body 1002.

FIG. 11 illustrates a method of removing an abutment, such as abutment 900, from a dental implant, such as dental implant 401, using the abutment removal tool 1001 of FIG. 10. To begin with, a dentist will slightly loosen dental screw 601, without removing it by slightly turning dental screw 601 counterclockwise. To turn dental screw 601 the dentist may utilize plunger 1002 or any other tool capable of engaging cavity 608 of dental screw 601. Then the dentist will slide insert body 1003 into abutment 900. Specifically, shaft 1011 of insert body 1003 is inserted into bore 908 of straight abutment 900. The dentist will then begin screwing insert body 1003 into abutment 900 by rotating head 1013 of insert body 1003 counterclockwise (since a left hand threading is used). As such, left hand threading 1012 located on insert body 1003 will engage left hand threading 918 inside straight abutment 900. The dentist will screw insert body 1003 counterclockwise until bottom portion 1015 of insert body 1003 contacts tip 922 at the end of treading 918 inside bore 908 of abutment 900.

Next, the dentist will insert hex driver body 1002 into insert body 1003. Specifically, shaft 1004 of hex driver body 1002 is inserted through bore 1014 of insert body 1003 and into cavity 608 of dental screw 601. Shaft 1004 is inserted until hex tip 1007 engages the hex shaped cavity 608 of dental screw 601. The dentist will then turn hex driver body 1002 counterclockwise to unscrew dental screw 601 from dental implant 401. The dentist may use a manual tool or a drill that engages head 1008 to turn driver body 1002. As dental screw 601 moves upward, its first end 604 will ultimately engage bottom portion 1015 of insert body 1003. Thereafter, as dental screw 601 continues to travel upward with respect to dental implant 401, it will force brace 1003 upward and thereby force straight abutment 900 upward. The upward force will move straight abutment 900 away from dental implant 401 causing them to separate. Using abutment removal tool 1001, the dentist may easily remove straight abutment 900 from dental implant 401.

The left-handed threading 1012 and 918 used to engage insert body 1003 to straight abutment 900 prevent insert body 1003 from being unscrewed from straight abutment 900. Specifically, as dental screw 601 and hex driver body 1002 rotate counterclockwise, they will force insert body 1003 to also rotate counterclockwise, thus further engaging dental implant 900. Since left-handed threading is used, insert body 1003 will remain intact with straight abutment 900 instead of being unscrewed if a regular threading would have been used.

Another abutment removal tool is illustrated in FIG. 12. Abutment removal tool 1201 is used to assist the dentist in disengaging an abutment, such as straight abutment 900, from a dental implant, such as dental implant 401. Abutment removal tool 1201 engages straight abutment 900 via threading 920 located at the lower portion of the abutment. Beneficially, abutment removal tool 1201 may also be used to disengage an angled abutment, such as abutment 501 (shown in FIG. 5A), from a dental implant, such as dental implant 401. In this configuration, threading (not shown) will be included within the narrower portion 503B of bore 503 on angled abutment 501 (similar to threading 920 of straight abutment 900).

Abutment removal tool 1201 comprises insert body 1203 and plunger body 1204. Plunger body 1204 comprises head 1213 and shaft 1215. Shaft 1215 includes thread 1207 on its upper section and tip 1209 on its lower section. Insert body 1203 comprises head 1220 and shaft 1221 having bore 1222 that is longitudinally coextensive with length of insert body 1203. Bore 1222 comprises a diameter adopted to receive shaft 1215 of plunger body 1204. Head 1220 includes cavity 1208 containing threads 1223. Shaft 1221 of insert body 1203 comprises a thinner end portion 1224 including threading 1214.

FIG. 13 illustrates a method of removing an abutment, such as abutment 900, from a dental implant, such as dental implant 401, using the abutment removal tool 1201 of FIG. 12. First, a dentist will remove dental screw 601 (shown in FIG. 11) securing abutment 900 to dental implant 401. Then, the dentist will slide insert body 1203 of tool 1201 into straight abutment 900. Specifically, shaft 1221 of insert body 1203 is inserted through bore 908 of abutment 900. The dentist then begins to screw insert body 1203 into abutment 900 in a clockwise direction by turning head 1220. This causes threads 1214 located on end portion 1224 of insert body 1203 engage threads 920 located on inner wall 913 of abutment 900.

Next, the dentist will insert the plunger body 1204 into insert body 1203. Specifically, shaft 1215 of plunger body 1204 is inserted into bore 1222 of insert body 1203. The dentist will then begin to screw plunger body 1204 into insert body 1203 by turning head 1213 clockwise. As such, threads 1207 of plunger body 1204 will engage threads 1223 located inside cavity 1208 of insert body 1203. As the dentist continues to screw plunger body 1204 into insert body 1203, tip 1209 at the end of shaft 1215 of plunger body 1204 will engage the aperture end 413 inside bore 403 of dental implant 401. As the dentist further screws plunger body 1204 into insert body 1203, shaft 1215 will press against dental implant 401 causing insert 1203 to travel upward and away from dental implant 401. Thereby, abutment 900, which is connected to insert body 1203 via threading 920 and 1214, is caused to travel in an upward direction and away from dental implant 401. As such, abutment 900 is forced to disengage from dental implant 401.

While the present invention has been described with reference to the preferred embodiment and alternative embodiments, which have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. For example, any element described herein may be provided in any desired size (e.g., any element described herein may be provided in any desired custom size or any element described herein may be provided in any desired size selected from a “family” of sizes, such as small, medium, large). It should be appreciated that the present invention is capable of being embodied in other forms without departing from its essential characteristics.

What is claimed is:

1. A dental assembly comprising:
a dental implant having a first body, a proximal mating area having a first tapered wall and a first internal aperture, wherein said proximal mating area further comprises a plurality of first anti-rotational elements;
an abutment having a second body, a second internal aperture and a distal mating area having a second tapered wall, wherein said second mating area further comprises a plurality of second anti-rotational elements; and wherein said proximal mating area is coupled to said distal mating area, thereby coupling said plurality of first anti-rotational elements to said plurality of second anti-rotational elements; and
a screw having a head portion and a threaded screw portion, wherein said threaded screw portion is coupled to said first internal aperture of said dental implant.

2. The dental assembly according to claim 1 wherein said anti-rotational elements allow for timing the geometry of said abutment to the required position of the oral cavity.

3. The dental assembly according to claim 1 wherein said first tapered wall and said second tapered wall are sloped at a range of 1-10 degrees.

4. The dental assembly according to claim 1 wherein said first tapered wall and said second tapered wall are sloped at a range of 1-5 degrees.

5. The dental assembly according to claim 1 wherein said first body further comprises a threaded portion for receiving said threaded screw portion, thereby coupling said dental implant to said screw.

6. The dental assembly according to claim 1 wherein said first tapered wall has a first angle, which is a same angle as second angle of said second tapered wall, thereby frictionally coupling said first tapered wall to said second tapered wall.

7. The dental assembly according to claim 1 wherein said dental implant further comprises a distal portion having a plurality of external threads, thereby coupling said dental implant to a jawbone.

8. The dental assembly according to claim 1 wherein said head portion includes a plurality of grooves and wherein said grooves are rotationally coupled to said dental screw.

9. The dental assembly according to claim 1 wherein said first tapered wall further comprises an inner wall, an upper wall and a bottom wall, wherein said inner wall is tapered between said upper wall and said bottom wall.

10. The dental assembly according to claim 1 wherein said abutment is a straight abutment.

11. The dental assembly according to claim 1 wherein said abutment is an angled abutment.

12. A dental device comprising:
a body having an external surface including a tapered wall, wherein said tapered wall is provided at a proximal end of said body, and wherein said tapered wall having a first upper wall and a second bottom wall;
a mating area included within said body and below said first upper wall having a first internal aperture, wherein said internal aperture comprises a second tapered wall and a plurality of anti-rotational elements; and
a bore provided within said body, below said proximal mating area, wherein said bore includes a plurality of internal threads.

13. The dental device according to claim 12 wherein said plurality of anti-rotational elements allow for timing the geometry of said dental device to the required position of the oral cavity.

14. The dental device according to claim 12 wherein said second tapered wall and said second tapered wall are sloped at a range of 1-10 degrees.

15. The dental device according to claim 12 wherein said second tapered wall and said second tapered wall are sloped at a range of 1-5 degrees.

16. An abutment comprising:
a body having an external surface, wherein said body includes a proximal end and a distal end;
a bore provided within said body, wherein said bore is longitudinal to said body and transverses the entire length of said body;
a mating area coupled to said proximal end of said body, wherein said mating area comprises a plurality of anti-rotational elements; and
a tapered wall coupled to said mating area, wherein said tapered wall has an upper wall and a bottom wall, wherein said tapered wall further comprises an inner wall having an angle from said upper wall to said bottom wall.

17. The abutment according to claim 16 wherein said plurality of anti-rotational elements allow for timing the geometry of said abutment to the required position of the oral cavity.

18. The abutment according to claim 12 wherein said tapered wall and said second tapered wall are sloped at a range of 1-10 degrees.

19. The abutment according to claim 12 wherein said tapered wall and said second tapered wall are sloped at a range of 1-5 degrees.

20. The abutment according to claim 12 wherein said external surface tapers from said proximal end to said distal end of said body.

21. A method of using a dental assembly comprising the steps of:
drilling a receiving aperture in a patients jawbone;
attaching a distal portion of a dental implant into the receiving aperture, wherein the dental implant also has a first body portion and a first aperture therein, wherein said first aperture comprises a proximal mating area having a first tapered wall and a first anti-rotational elements and a bore positioned underneath, wherein said bore comprises a plurality of internal threads;
attaching a second mating area of an abutment to the proximal mating area, wherein the second mating area having a second tapered wall and a second anti-rotational elements, thereby locking the abutment to the dental implant, wherein the abutment also having a second body and a second internal aperture traversing therethrough;
inserting a screw into the second internal aperture; and
rotating the screw thereby threadably coupling the dental screw to the dental implant.

22. The method of claim 21 further comprising the step of receiving the screw within a threaded portion of the first body portion.

23. The method of claim 21 further comprising the step of coupling the threaded portion of the screw to said first internal aperture of the dental implant, wherein the screw further includes a head portion.

24. The method of claim 21 further comprising the step of coupling the first anti-rotational elements to the second anti-rotational elements.
